(19) United States
(12) Patent Application Publication
(10) Pub. No.: US 2026/0276019 A1
(43) Pub. Date: Sep. 17, 2026

(54) FASTENING ARRANGEMENT, COMPONENT STRUCTURE WITH THE FASTENING ARRANGEMENT AS WELL AS ASSOCIATED FASTENING METHOD

(71) Applicant: Böllhoff Verbindungstechnik GmbH, Bielefeld (DE)

(72) Inventors: Thorsten STALLMANN, Löhne (DE); Heinrich HEINRICHS, Vlotho (DE)

(21) Appl. No.: 19/256,940

(22) Filed: Jul. 1, 2025

(30) Foreign Application Priority Data
Jul. 2, 2024 (DE) 102024118763.8

(51) Int. Cl. F16B 21/18; F16B 21/02

(52) U.S. Cl. CPC F16B 21/18; F16B 21/02

(57) ABSTRACT

A fastening arrangement for fastening a first component with a component opening to a second component with manual compensation of a distance therebetween. The fastening arrangement comprises a hollow-cylindrical fastening element with a shaft portion and a head portion the head portion projecting radially to the outside beyond the shaft portion with a circumferential flange or a plurality of first projections and a plurality of second projections with the circumferential flange or the plurality of first projections and the plurality of second projections being arranged with a distance to one another in axial direction, so that a rim of the component opening is arrangeable in the first component between the circumferential flange or the plurality of first projections and the plurality of second projections and the shaft portion comprises a plurality of fastening sections and a plurality of insertion sections on its radial outside which are alternately arranged in circumferential direction and extend in axial direction between head portion and an axial end of the shaft portion with the fastening sections projecting in radial direction beyond the insertion sections a receiving opening of the second component which in circumferential direction alternately comprises portions which project radially into and portions which are set-back from the receiving opening so that the fastening element is pluggable through the component opening in the first component into the receiving opening and is rotatable relative to the receiving opening, with a fixation of the first component between the circumferential flange and the plurality of second projections being caused by inserting the fastening element or between the plurality of first and second projections by rotating the fastening element as well as a fixation of the first component to the second component by rotating the fastening element.

### 1. FIELD OF THE INVENTION

The present invention refers to a fastening arrangement for fastening a first component with a component opening to a second component with manual compensation of a distance therebetween, a component structure out of two components, connected by means of the fastening arrangement, as well as a fastening method for fastening a first component with a component opening to a second component by using the fastening arrangement.

### 2. BACKGROUND OF THE INVENTION

A large variety of fastening arrangements for fastening a first component with a component opening to a second component with manual compensation of a distance therebetween is known in the state of the art. In particular, such arrangements are used in the automotive sector, e.g. for connecting an add-on part or a component such as a headlamp with the vehicle body. Here, a difference is made between two kinds of arrangements, namely those where the distance is compensated automatically and those where the compensation takes place manually.

A headlamp assembly with self-adjusting fasteners is for example described in U.S. Pat. No. 9,150,145 B2. The headlamp assembly comprises a brace, a headlamp and a plurality of self-adjusting fasteners. The self-adjusting fasteners are configured to adjust during the assembly of the headlamp to the retainer to compensate for irregular spacing between the headlamp and the retainer caused by variations in manufacturing. That means, this is a fastening arrangement with automatic tolerance compensation.

From EP 1 080 292 A1, an arrangement of a deck lid bumper for a vehicle is known. The deck lid bumper has a stud with a head and a shaft, the head being inclined so as to bump against the deck lid, as well as a receiver for receiving the shaft of the bolt. The receiver comprises means for fastening the receptable in a frame. A friction surface is provided between the shaft of the stud and the receptable which is sufficient to support the stud in a desired position within the receptable. Furthermore, a lock is provided to lock the shaft portion of the stud into the receptable by rotating the head of the stud with respect to the receptable.

A spacer assembly is disclosed in DE 10 2018 125 724 A1. The spacer assembly comprises a housing which is adapted to be coupled to a component. The housing comprises a central bore hole. A bumper is coupled to the housing. The bumper comprises a bumper support having a shaft extending into the central bore hole, and a bumper head coupled to the bumper support.

Finally, a fastening arrangement for fastening a first component to a second component is known from DE 10 2012 011 848 A1. The fastening arrangement comprises a cylindrical element with an outer lateral surface and a sleeve-like element with an inner lateral surface, by means of which the two components are variably fastenable or fastened to one another. Furthermore, the fastening arrangement comprises a rip which is formed at one of the lateral surfaces of the cylindrical or sleeve-like element and which is principally aligned perpendicular to the axis of the cylindrical and sleeve-like element. Furthermore, a projection is provided which is arranged at the other of the lateral surfaces of the sleeve-like or the cylindrical element. The rip and the projection are configured at the cylindrical and sleeve-like element in a way that the sleeve-like element can be plugged onto the cylindrical element and the cylindrical element is rotatable relative to the mounted sleeve-like element in variable axial positions around the axis. When rotating, the rip is brought into connection with the projection so that the cylindrical element is fixed in axial direction relative to the plugged-on or mounted sleeve-like element.

Particularly systems with an automatic tolerance compensation require a plurality of different components as here, the principle of functionality is often based on the fact that by introducing a fastening element, the tolerance compensation is achieved. In contrast to that, with non-automatic systems, the distance must be manually compensated before fastening the components to each other. Only then is the fastening element inserted into the components for fastening the components to each other. Thus, systems with manual tolerance compensation also often comprise a plurality of different components.

It is therefore the object of the present invention to provide a fastening arrangement for manual tolerance compensation which, compared to the state of the art, is optimized with regard to the handling and which implements a reliable connection between the components at the same time.

### 3. SUMMARY OF THE INVENTION

The above object is solved by a fastening arrangement for fastening a first component with a component opening to a second component with manual compensation of a distance therebetween according to the independent claim 1 or according to the independent claim 2, a component structure according to the independent claim 11 as well as a fastening method for fastening a first component with a component opening to a second component according to the independent claim 14 or according to the independent claim 15. Advantageous embodiments and further developments arise from the following description, the drawings as well as the appending claims.

A first alternative of an inventive fastening arrangement for fastening a first component with a component opening to a second component with manual compensation of a distance therebetween comprises a hollow-cylindrical fastening element with a shaft portion and a head portion, the head portion projecting radially to the outside beyond the shaft portion with a circumferential flange or a plurality of first projections and a plurality of second projections, with the circumferential flange or the plurality of first projections and the plurality of second projections being arranged with a distance to one another in axial direction, so that a rim of the component opening in the first component is arrangeable between the circumferential flange or the plurality of first projections and the plurality of second projections and the shaft portion comprises a plurality of fastening sections and a plurality of insertion sections on its radial outside which are alternately arranged in circumferential direction and extend in axial direction between head portion and an axial end of the shaft portion, with the fastening sections projecting in radial direction beyond the insertion sections, a receiving opening of the second component, which in circumferential direction alternately comprises portions projecting radially in and being set-back radially in the receiving opening, so that the fastening element is insertable through the component opening in the first component into the receiving opening and is rotatable relative to the receiving opening, with a fixation of the first component between the circumferential flange and the plurality of second projections being caused by inserting the fastening element or between the plurality of first and second projections by rotating the fastening element as well as a fixation of the first component to the second component in axial direction by rotating the fastening element.

For a better understanding, the use of the fastening arrangement is explained next. Here, the starting point is that the first and the second component are arranged to one another with a spacing or distance therebetween. In doing so, the component opening of the first component is aligned with the receiving opening. The receiving opening is either an integral part of the second component or of a third component which is arranged to the second component. For example, the third component is shifted laterally onto a rim of the second component and/or is fastened to the second component in a loss-proof manner. This will be explained in more detail later.

On the basis of the components that are arranged in this way, the fastening element is inserted into the component opening of the first component with the shaft portion ahead. With the fastening element having the plurality of first and second projections, the plurality of first projections is formed by the projections which are present adjacent to the head, while the projections axially spaced from same in the direction of the shaft end form the second plurality of projections. In the embodiment with the plurality of first and second projections, same are advantageously arranged in circumferential direction in an offset manner with respect to one another. Furthermore, the component opening is preferably configured complimentary to the shape of the plurality of second projections. In case of two second projections, which are spaced apart by 180°, the component opening is therefore present in the form of a keyhole.

In case of the fastening element with the circumferential flange and the plurality of second projections, the circumferential flange is present adjacent to the head, while the projections, preferably latching noses, that are axially spaced from same in the direction of the shaft end, form the second plurality of projections.

During the inserting of the fastening element with the plurality of first and second projections into the component opening of the first component, the plurality of second projections passes the component opening. The plurality of first projections, which are preferably arranged circumferentially in an offset manner with respect to the plurality of second projections, abuts the component surface. For example, two first projections are present which are provided opposite one another and are arranged in an offset manner by 90° with respect to the second projections.

With regard to the receiving opening, the inserting takes place in a way that the insertion sections are aligned with the projecting portions of the receiving opening. Thus, a movability of the fastening element in the receiving opening in axial direction is easily possible. By that, the required distance between the two components can be considered.

As soon as the fastening element with the plurality of first projections attaches the surface of the first component, a rotating of the fastening element takes place. By that, the plurality of second projections is moved away from the recesses in the component opening and engages with the component surface on the second side. The plurality of first projections still remains in contact with the component surface, though on the opposite first side. Thus, the first component is fixed between the plurality of first and second projections. A distance between the plurality of first and second projections in axial direction is therefore adapted to a thickness of the first component in the fastening portion.

Such a rotation of the fastening element additionally causes the fastening sections to come into engagement with the projecting portions of the receiving opening. Thus, a fixation in axial direction takes place.

As soon as this has taken place, the two components are fastened with a distance to each other, with the first component being firmly arranged between the plurality of first and the plurality of second projections in the head portion of the fastening element. The second component is located in the desired, defined distance.

When inserting the fastening element with the circumferential flange and the plurality of second projections into the component opening of the first component, the plurality of second projections passes the component opening. After that, the circumferential flange abuts the component surface. As explained above, the inserting with respect to the receiving opening will take place in a way that the insertion sections are aligned with the projecting portions of the receiving opening. Thus, a movability of the fastening element in the receiving opening in axial direction is easily possible and the desired distance between the two components can be taken into account.

In contrast to the above embodiment with the plurality of first and second projections, in case of the combination of circumferential flange and the plurality of second projections, which are preferably latching noses, an inserting of the fastening element into the component opening already causes a fixing of the first component between the circumferential flange and the plurality of second projections. A distance between the circumferential flange and the plurality of second projections in axial direction is therefore adapted to a thickness of the first component in the fastening portion.

As is the case in the previous embodiment, here, a rotation of the fastening element also leads to an engagement of the fastening sections with the projecting portions of the receiving opening. By that, a fixation in axial direction takes place.

As soon as this has taken place, the two components are fastened with a distance to each other, with the first component firmly arranged between the circumferential flange and the plurality of second projections in the head portion of the fastening element. The second component is located at the desired, defined distance.

An advantage of this approach is that no additional fastening means must be used. Preferably, the use of a screw for securing and fastening the components to each other is no longer necessary.

Furthermore, the arrangement provides a robust fastening arrangement which is applied easily, is manufactured at a reasonable price and does not consist of multiple parts but of two elements, only.

A corresponding locking takes place depending on the number of projections and/or the fastening sections by means of a rotation for example by 30° or 60°, though other rotation angles are preferred as well, which particularly lie between 30° and 60°, such as for example 45°. A rotation by 45° for locking the fastening element in the receiving opening may for example be used with the above-mentioned example with two first and two second projections. This applies analogously to the fixation in axial direction when using two fastening sections.

A second alternative of an inventive fastening arrangement for fastening a first component with a component opening to a second component with manual compensation of a distance therebetween comprises a hollow-cylindrically formed fastening element with a shaft portion and a head portion, the head portion projecting radially to the outside beyond the shaft portion with a plurality of first and second projections, with the plurality of first and second projections being spaced from one another in axial direction and arranged in circumferential direction in an offset manner to each other, so that a rim of the component opening in the first component is arrangeable between the plurality of first and second projections and on its radial inside in circumferential direction, the shaft portion comprises portions which alternately project radially in and are set-back radially in an internal space, a securing element providing a projection extending perpendicularly from a surface of the second component, the projection having a plurality of fastening sections and a plurality of insertion sections on its radial outside each of which being alternately arranged in circumferential direction and extend in axial direction between the second component and an axial end of the securing element, with the fastening sections projecting further out in radial direction than the insertion sections so that the fastening element is pluggable through a component opening in the first component onto the securing element and is rotatable relative to the securing element, with a rotation of the fastening element causing a fixing of the first component between the plurality of first and second projections as well as a fixing of the first component to the second component in axial direction.

The functionality of the second alternative of the inventive fastening arrangement is similar to that of the first alternative. In contrast to the first alternative, however, no receiving opening at the second component is provided but a securing element, which provides a projection at the second component extending perpendicularly from the surface of the second component. The design of the projection is analogous to the shaft portion of the first alternative of the fastening arrangement. Accordingly, the fastening element of the second alternative has a design which on the inside is analogous to the receiving opening of the first alternative of the fastening arrangement.

In order to explain the resulting functionality, it is again assumed that the first and the second component are arranged to one another with a distance therebetween. The component opening of the first component is aligned with the securing element. The securing element is either an integral part of the second component or is provided by a third component which is arranged at or fastened to the second component.

On the basis of the components which are arranged like that, the fastening element is inserted through the component opening of the first component with the shaft portion ahead. The plurality of first projections is formed by the projections which are present adjacent to the head, while the projections which are axially spaced from them in the direction of the shaft end form the second plurality of projections. Preferably, the component opening is formed complementary to the shape of the plurality of second projections. In case of two second projections, that are spaced from each other by 180°, the component opening is therefore present in the form of a keyhole.

When inserting the fastening element into the component opening of the first component, the plurality of second projections passes the component opening, while the plurality of first projections, which are circumferentially arranged in an offset manner with respect to the plurality of second projections, attaches the component surface. The insertion sections of the securing element are aligned with the projecting portions of the shaft portion. Thus, a movability of the fastening elements in axial direction with respect to the securing element is easily possible. Just as in case of the previous alternative, the desired distance between the two components can be considered by that.

As soon as the fastening element attaches the surface of the first alternative with the plurality of first projections, a rotation of the fastening element takes place. By that, the plurality of second projections is moved away from the recesses in the component opening and comes into engagement with the component surface at a second side. The plurality of first projections still remains in contact with the component surface, though on the opposite first side. Thus, the first component is fixed between the plurality of first and second projections. A distance between the plurality of first and second projections in axial direction is therefore adapted to a thickness of the first component in the fastening portion.

Such rotation of the fastening element furthermore causes the projecting portions of the fastening element to come into engagement with the fastening sections of the securing element, i.e. a fixing in axial direction takes place by that.

As soon as this has taken place, the two components are fastened to each other with a distance, the first component being firmly arranged between the plurality of first and the plurality of second projections in the head portion of the fastening element. The second component is located in the desired, defined distance.

The resulting advantages correspond to the advantages discussed above for the first alternative. For clarity reasons, reference is therefore made to the above explanations.

In a preferred embodiment of the fastening arrangement, at least one insertion section comprises an axially extending web adjacent to a fastening section, the web projecting radially from the insertion section and providing a stop for limiting the rotation of the fastening element for the respective, projecting portion. With the help of the axially extending web, an over-rotation of the fastening element is therefore prevented.

It is furthermore preferred that each fastening section comprises a plurality of teeth. Advantageously, the teeth taper in the tightening direction of the fastening element and/or their radial extension becomes less. Due to this configuration, the fastening arrangement is fixable in different axial positions, in particular depending on the axial length of the shaft portion of the fastening element. Furthermore, and considering that there is a relaxation over time of the plastic as the material for the receiving opening or the fastening element, when same comprises the projecting and set-back portions, a reverse-lock in the portion of the declining flange of the respective tooth is formed.

In a further advantageous embodiment of the fastening arrangement with the teeth, the teeth are arranged perpendicularly to a longitudinal axis that is defined by the shaft portion of the fastening element or perpendicularly to a longitudinal axis that is defined by the projection of the securing element or two neighboring teeth are arranged mirror-symmetrically with respect to a plane surface between the teeth, the plane surface being aligned perpendicularly to the longitudinal axis, with the neighboring teeth enclosing an angle of 1°, preferably 2° and particularly preferred 3° with the plane surface. Particularly those teeth which extend perpendicularly have the advantage that there is no application of additional axial forces between the components to be connected. In contrast to that, the embodiment with teeth, mirror-symmetrical with respect to the plane between the teeth, has the advantage that an additional anti-rotation security is generated. Again, the reason for this is the relaxation behavior of the plastic material as the material for the portion with the receiving opening or for the fastening element when using a securing element.

In a preferred embodiment of the fastening arrangement, the fastening element includes a drive feature in the head portion. The fastening element is locked in the first component by means of the respective drive feature. Thus, the drive feature enables a rotation of the fastening element. For this purpose, the drive feature can be an inner or an outer drive feature, e.g. a hexagon socket or an external hex. In particular with regard to the first alternative, an inner drive feature is preferred, while with regard to the second alternative, both an inner as well as an outer drive feature are preferred.

Preferably, the circumferential flange or the plurality of first projections is present adjacent to a first axial end of the fastening element and the plurality of second projections comprises at least one rip on a surface facing the circumferential flange or the plurality of first projections. The rip additionally supports the fastening of the first component in the head portion. In addition, the plurality of second projections may also comprise a ramp bevell so as to support tightening of the fastening element and retention of the first component between the first and the second projections.

In connection with the first alternative of the inventive fastening arrangement, it is preferred that the fastening element is made of a material that is harder than the material in which the receiving opening is formed. That way, it can specifically be guaranteed that the teeth can dig into the softer material so that the fixation in axial direction can be effected particularly reliably. Another advantage arising from that, particularly in case the receiving opening is provided by a separate, third component is, that the deforming, softer element may be exchanged more easily and better in case of an erroneous or new setting of the distance. In this case, PPA-GF50 could for example be considered as the material for the fastening element. The receiving opening should therefore be formed in a softer material, preferably a softer plastic material.

Finally, in connection with the second alternative of the inventive fastening arrangement, it is preferred that the securing element is made of a material which is harder than the material of the fastening element. Thus, the advantages which have just been described arise analogously for the second alternative, too. In this case, PPF-GF50 can for example be considered as the material for the securing element, while a softer material, in particular a softer plastic material, is used for the fastening element.

An inventive component structure is made of a first component with component opening and a second component, the first and the second component connected with each other by means of the inventive fastening arrangement with a distance to each other. Thus, in the inventive component structure, the inventive fastening arrangement is therefore used for fastening the components to one another. With regard to the resulting advantages, reference is therefore made to the above explanations in order to avoid repetitions.

In a preferred embodiment of the component structure, the fastening arrangement is a fastening arrangement in connection with the first alternative of the inventive fastening arrangement and the receiving opening is an integral part of the second component or a separate third component which is arranged at the second component, preferably, it is shifted laterally on a rim of the second component and/or is fastened in the second component in a loss-proof manner. Due to the integral configuration, the necessity of further components can be avoided, so that use becomes easier. Compared to this, the provision via a third component allows higher flexibility, as the third component can be replaced and adapted as required to the respective conditions for use.

In another preferred embodiment of the component structure, the fastening arrangement is a fastening arrangement in connection with the second alternative of the inventive fastening arrangement and the securing element is an integral part of the second component or the securing element is a separate third component which is fastened to the second component. With respect to the advantages of the integral or separate configuration of the securing element, reference is made to the previous embodiment and the provision of the receiving opening in order to avoid repetitions.

A first alternative of an inventive fastening method for fastening a first component with a component opening to a second component by using the first alternative of the inventive fastening arrangement comprises the steps: arranging the first component at a required distance to the second component, with the component opening of the first component being aligned with the receiving opening of the second component, inserting the fastening element into the component opening of the first component until the circumferential flange or the plurality of first projections abut the first component and the shaft portion engages into the receiving opening of the second component, with the insertion sections being aligned with the projecting portions and the fastening sections being aligned with the set-back portions, after that, rotating the fasting element so that a fixing of the first component at the second component is caused in axial direction. An inventive component structure is realized by means of the fastening method. When using the embodiment of the fastening element with the circumferential flange and the plurality of second projections, preferably a plurality of latching noses, the inserting of the fastening element into the component opening of the first component already causes a fixation of the first component between the circumferential flange and the plurality of second projections. When the embodiment of the fastening element with the plurality of first and second projections is used, the rotation after inserting the fastening element into the component opening in the first component does not only cause a fixation of the first component to the second component in axial direction but additionally a fixation of the first component between the plurality of first and second projections. With respect to the arising technical effects and advantages, reference is made to the above statements regarding the first alternative of an inventive fastening arrangement.

A second alternative of an inventive fastening method for fastening a first component with a component opening to a second component by using a second alternative of an inventive fastening arrangement comprises the steps: arranging the first component with a desired distance to the second component, with the component opening of the first component being aligned with the securing element, inserting the fastening element into the component opening of the first component until the plurality of first projections abuts the first component and the shaft portion engages into the securing element, with the projecting portions being aligned with the insertion sections of the securing element and the set-back portions being aligned with the fastening sections of the securing element, after that, rotating the fastening element so that a fixing of the first component between the plurality of first and second projections as well as a fixing of the first component at the second component is caused in axial direction. With the fastening method, too, an inventive component structure is realized, however, by using the second alternative of the inventive fastening arrangement. With regard to the arising technical effects and advantages, reference is therefore made to the above statements regarding the second alternative of the inventive fastening arrangement.

### 4. SHORT SUMMARY OF THE DRAWINGS

In the following, the present invention will be described in detail based on the drawings. In the drawings, the same reference signs refer to the same components and/or elements. They show:

FIG. 1 a perspective view of a component structure with a first alternative of an embodiment of an inventive fastening arrangement in a partial sectional view in a non-fastened state,

FIG. 2 a top view on the component structure according to FIG. 1,

FIG. 3 a sectional view of the component structure according to FIG. 1,

FIG. 4 a perspective view of the component structure with the first alternative of an embodiment of the inventive fastening arrangement in a partial sectional view in a fastened state,

FIG. 5 a top view on the component structure according to FIG. 4,

FIG. 6 a sectional view of the component structure according to FIG. 4,

FIG. 7 a partial sectional view of the component structure according to FIG. 4,

FIG. 8 a partial sectional view of the component structure according to FIG. 4,

FIG. 9 a lateral view of a further embodiment of a fastening element,

FIG. 10 a perspective view of a component structure with a second alternative of an embodiment of an inventive fastening arrangement in a partial sectional view in a non-fastened state,

FIG. 11 a top view on the component structure according to FIG. 10,

FIG. 12 a sectional view of the component structure according to FIG. 10,

FIG. 13 a perspective view of the component structure with the second alternative of an embodiment of the inventive fastening arrangement in a partial sectional view in a fastened state,

FIG. 14 a top view on the component structure according to FIG. 13,

FIG. 15 a sectional view of the component structure according to FIG. 13,

FIG. 16 a partial sectional view of the component structure according to FIG. 13,

FIG. 17 a perspective view of a component structure with another embodiment of the first alternative of the inventive fastening arrangement in a sectional view in a non-fastened state,

FIG. 18 a schematic flow chart of an embodiment of a first alternative of an inventive fastening method and

FIG. 19 a schematic flow chart of an embodiment of a second alternative of an inventive fastening method.

### 5. DETAILED DESCRIPTION OF THE PREFERRED EMBODIMENTS

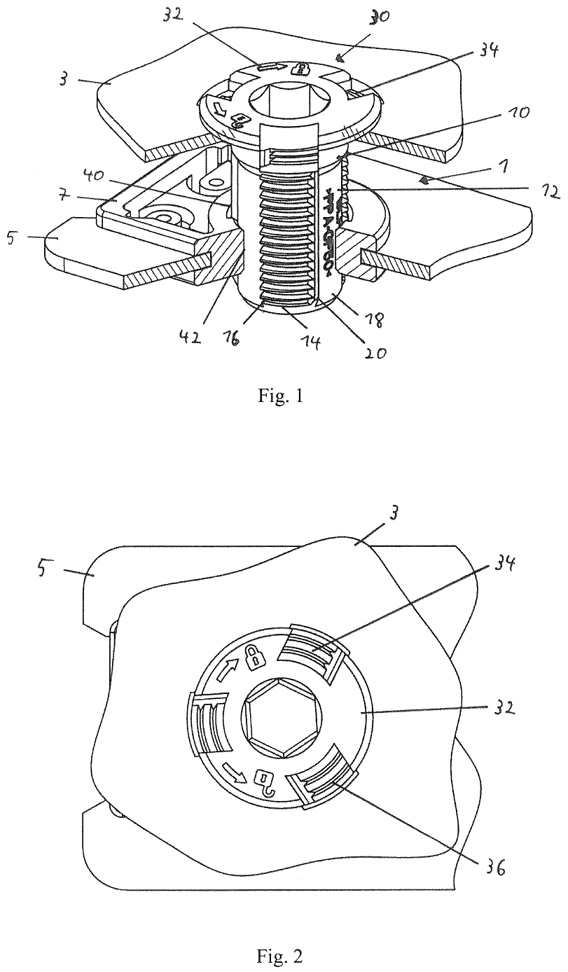

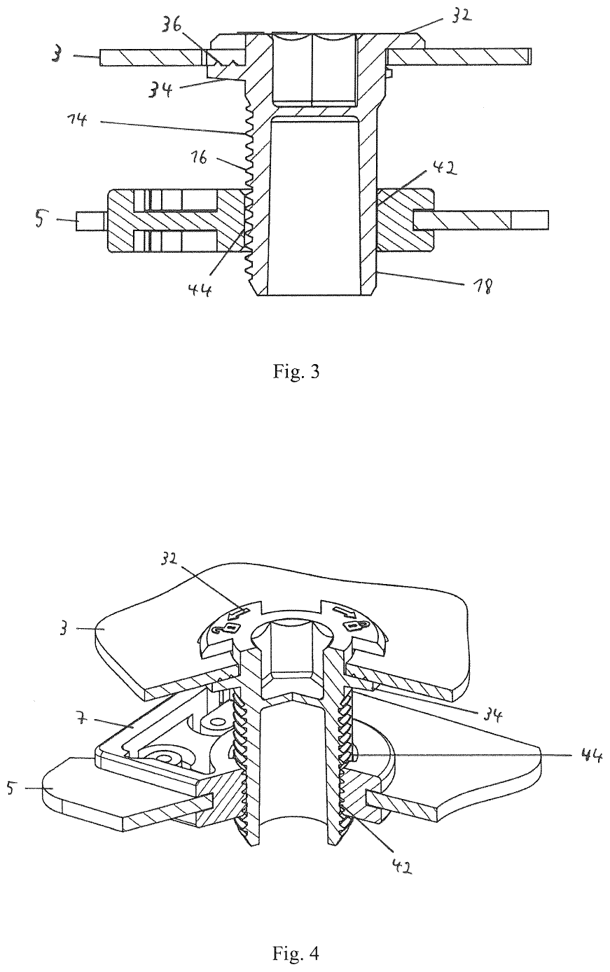

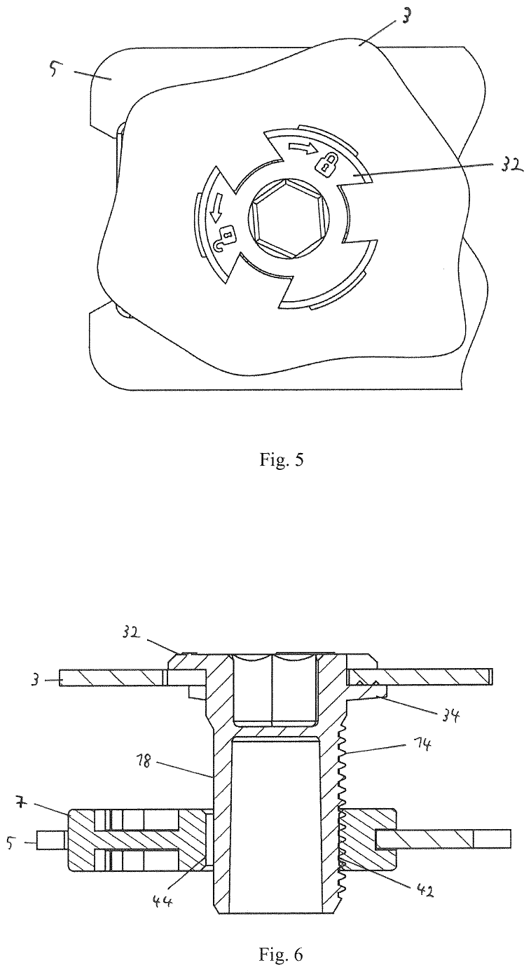

Hereinafter, an embodiment of a first alternative of an inventive fastening arrangement 1 with reference to the use in a component structure is explained. This is carried out with particular reference to FIGS. 1 to 8. While FIGS. 1 to 3 show the fastening arrangement 1 in a state of being inserted into a first component 3 and a second component 5 but not fastened in same, FIGS. 4 to 7 show the fastening arrangement 1 in a fastened state. FIG. 8 serves for illustrating the structure when a receiving opening 40 is provided by means of a third component 7.

The fastening arrangement 1 is made of a hollow-cylindrical fastening element 10 as well as a receiving opening 40 of the second component 5.

The fastening element 10 comprises a shaft portion 12 and a head portion 30. The head portion comprises first 32 and second projections 34 which radially project to the outside beyond the shaft portion 12. In the illustrated embodiment, three first projections 32 and three second projections 34 are provided. The first 32 as well as the second projections 34 are evenly spaced from one another circumferentially. With respect to a geometric center of each first projection, they are spaced in circumferential direction by 120°. The same applies analogously to the second projections 34.

The second projections 34 are axially spaced from the first projections 32 in the direction of the shaft end. A distance in axial direction between the first projections 32 and the second projections 34 preferably correspond to a thickness of the first component 3 in the fastening portion.

Besides this axial distance of the first 32 and the second projections 34, the first 32 and second projections 34 are also arranged circumferentially in a displaced manner to one another. As can be seen in FIG. 2, the first 32 and the second projections 34 alternate in circumferential direction.

A component opening in the first component 3 has a shape that is configured complementary with respect to the shape of the second projections 34. That means, the component opening comprises three recesses, the geometric center points of which are offset by 120°. That way, the fastening element 10 can be inserted into the component opening of the first component, until the first projections 32 lie on the surface of the first component 3 adjacent to the component opening.

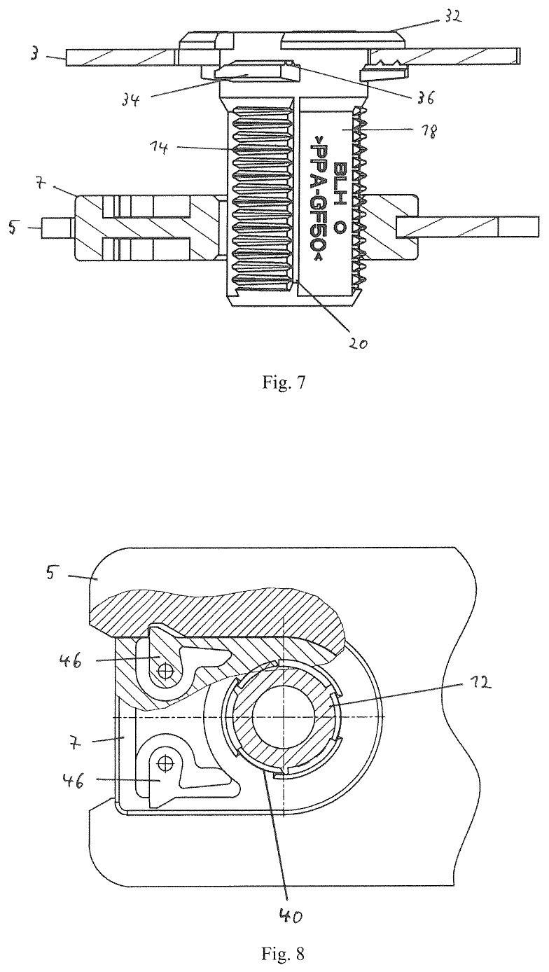

As can particularly be seen based on FIG. 2, the plurality of second projections 34 comprises at least one rip 36 on a side facing the plurality of first projections 32. In the present embodiment, two rips 36 are provided. The fastening of the first component 3 between the first 32 and the second projections 34 can be further improved by that. In this context, it is also preferred that the second projections 34 comprise a ramp bevel, as is for example shown in FIG. 7.

In circumferential direction, the shaft portion 12 is alternately made of a fastening section 14 and an insertion section 18. With respect to the fastening section 14, the insertion section 18 is offset radially to the inside and preferably, it has a smooth configuration. In axial direction, the fastening sections 14 are aligned with the second projections 34, while the insertion sections 18 are aligned with the first projections 32. Thus, in circumferential direction, the fastening sections 14 therefore comprise an extension which corresponds to the circumferential extension of the second projections 34. The same applies analogously to the insertion sections 18 with regard to the first projections 32.

The insertion section 18 has an axially extending web 20 adjacent to the fastening section 14. It projects radially from the insertion section 18 and provides a stop for limiting the rotation of the fastening element 10. Therefore, the web 20 is arranged behind the fastening section 14 in the tightening direction of the fastening element 10.

The fastening section 14 comprises a plurality of teeth 16. In the illustrated embodiment, the teeth 16 extend perpendicularly to a longitudinal axis that is defined by the shaft portion 12 of the fastening element 10. By that, a fastening of the first 3 and second component 5 to each other without applying axial forces to the fastening arrangement 1 can be realized.

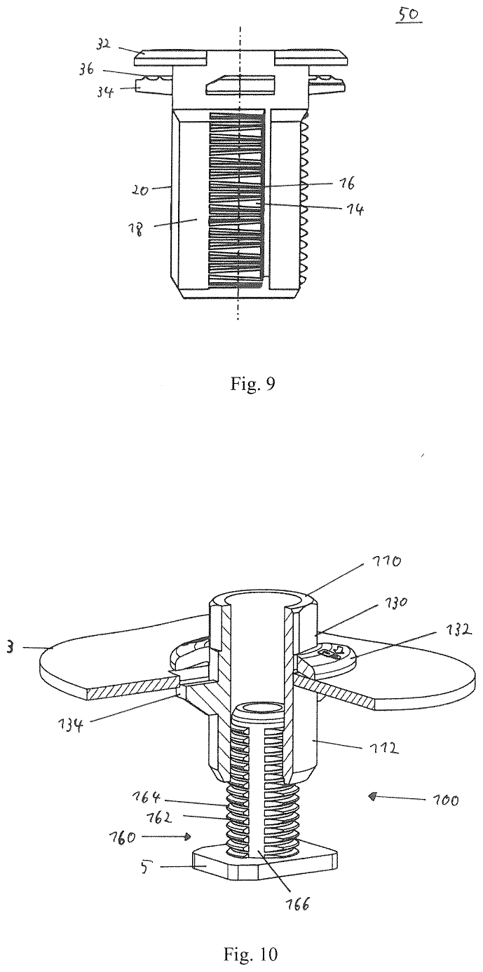

Alternatively, FIG. 9 shows a fastening element 50 that is designed differently. With this fastening element 50, two neighboring teeth 16 are arranged mirror-symmetrically with respect to a plane between the teeth 16, the plane aligned perpendicular to the longitudinal axis. Here, the neighboring teeth enclose an angle of 1°, preferably 2° and particularly preferred 3° with the respective plane. That way, a reverse motion lock is generated so that the fastening element 50 is held particularly reliably in the receiving opening 40. Apart from that, the fastening element 50 corresponds to the fastening element 10.

In order to provide a reverse motion lock, the teeth 16 taper in the tightening direction of the fastening element 10. Alternatively or additionally, the radial extension of the teeth 16 reduces in the tightening direction, which will also provide a reverse motion lock due to the relaxation behavior of the third component 7 made of plastic material.

Furthermore, the fastening arrangement 1 comprises a receiving opening 40 of the second component 5. In the illustrated embodiment, the receiving opening 40 is provided by a separate third component 7. For this reason, the second component 5 comprises, at the component rim, a recess in the shape of a rectangular with set-back portions that are arranged opposite one another. The third component 7 comprises a circumferential groove, the height of which corresponds to the thickness of the second component 5. Furthermore, two elastic elements 46 are provided which engage into the set-back portions of the second component 5 and exacerbate or hinder a moving of the third component 7 contrary to an insertion direction of the third component 7 into the second component 5. This can be seen in FIG. 8.

During an inserting of the third component 7 with the receiving opening 40 into the second component 5, the elastic elements 46 therefore initially move elastically towards each other and then move back elastically to the outside and lock there when reaching the set-back portions of the second component 5. Due to the groove in the third component 7, a movement of the third component 7 perpendicularly to a surface of the second component 5 is limited or prevented. Due to the provisioning of the receiving opening 40 in the separate third component 7, a new third component 7 can be used when the connection needs to be released and generated anew later. Particularly by that, it is feasible that the connection between fastening element 10 and receiving opening 40 comprises the original reliability again.

With further reference to the receiving opening 40, same comprises in circumferential direction alternating portions 42 and 44, radially projecting in 42 and being radially set-back in 44 the receiving opening 40. The functionality of the interaction between the receiving opening 40 and the fastening element 10 is subsequently explained based on establishing the connection between the first 3 and the second component 5.

When the first component 3 and the second component 5 have been arranged with the required distance to each other, the fastening element 10 is inserted through the component opening in the first component 3. As the component opening in the first component 3 is shaped complementary to the configuration with the second projections 34, the second projections 34 can pass through the component 3 while the first projections 32 lie on the component surface.

Furthermore, the receiving opening 40 is arranged in a way that the insertion section 18 of the fastening element 10 is aligned with the projecting portion 42 of the receiving opening 40 and the fastening section 14 is aligned with the set-back portion 44. Thus, the fastening element 10 is guided in axial direction in the receiving opening 40.

As soon as the first projections 32 abut the component surface of the first component 3, the position can be fixed in axial direction by rotating the fastening element 10. For this purpose, the fastening element 10 comprises a drive feature in the head portion 30. In the illustrated embodiment, this is an inner drive feature in the form of a hexagonal socket. Due to the displacement between the projections by 120°, as explained above, a rotation preferably takes place in an angular range between 30° and 60°. In the embodiment with the three first 32 and three second projections 34, the rotation preferably takes place by exactly 60°.

By means of the rotating of the fastening element 10, the teeth 16 in the fastening section 14 are brought into engagement with the projecting portions 42 of the receiving opening 40. In doing so, the teeth 16 preferably dig into the material of the projecting portions 42 or the receiving opening 40, respectively.

In order to realize a safe fastening of the fastening element 10 in the receiving opening 40, the fastening element 10 is made of a material which is harder than the material in which the receiving opening 40 is formed. The fastening element 10 is for example made of PPA-GF50. The advantage of this is that the fastening element 10 or the teeth 16, respectively, of the fastening element 10 can optimally dig into the projecting portions 42 of the receiving opening 40.

As soon as the connection between the first 3 and the second component 5 has been established in this way, no further fastening element, such as a fastening screw or the like, is preferably necessary at this connection point for securely fastening the two components to one another.

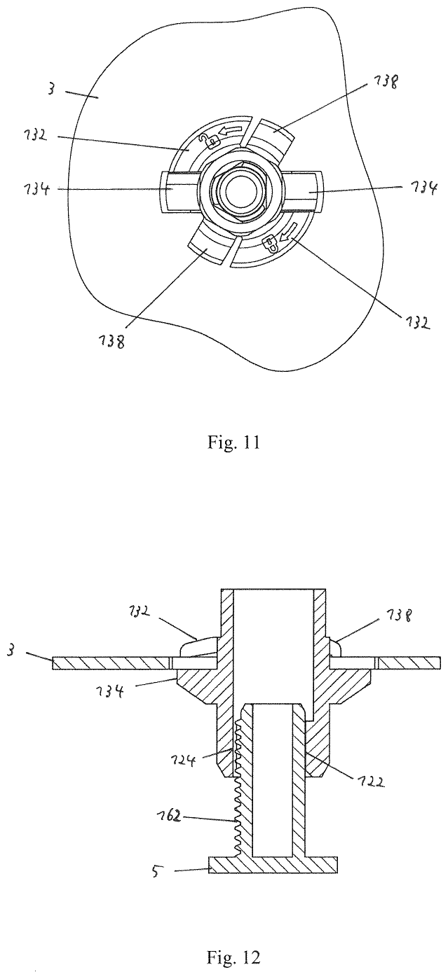

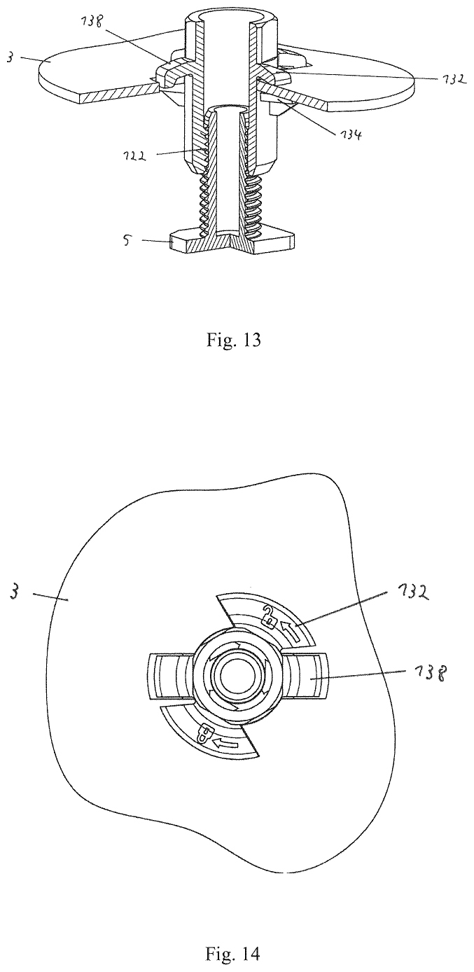

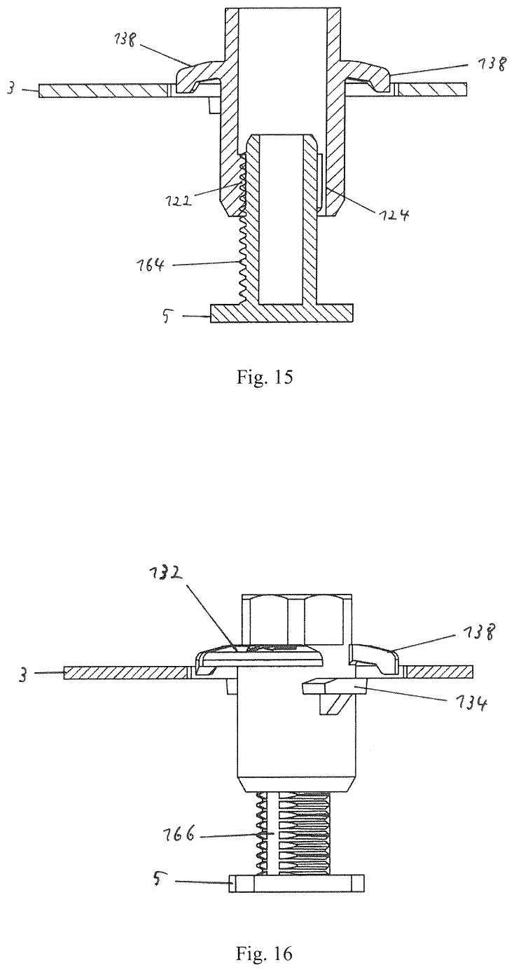

With reference to FIGS. 10 to 16, an embodiment according to a second alternative of an inventive fastening arrangement 100 is shown. Same components will be marked with same reference signs.

The fastening arrangement 100 is made of a fastening element 110 with a head portion 130 and a shaft portion 112. In the known manner, the head portion 130 comprises a plurality of first 132 and second projections 134. In the illustrated embodiment, two second projections 134 and two first projections 132 are present. They are arranged in a displaced manner by 180° to each other.

Instead of the fastening sections 14 and insertion sections 18 which are provided on the radial outside in the previous embodiment, projecting 122 and set-back portions 124 are provided in the shaft portion 112 on the radial inside. In the previous embodiment, they were located in the receiving opening 40.

Instead of the receiving opening 40, a securing element 160 is therefore provided in this embodiment. It provides a projection projecting perpendicularly from the surface of the second component 7, the projection comprising the fastening sections 162 with the teeth 164 as well as the insertion sections 166 on its radial outside.

The securing element 160 is either an integral part of the second component 5 or provided as a separate third component, which is fastened to the second component 5. The arising functionality is similar to the one mentioned above, so that reference is made to these explanations.

Likewise, the above explanations regarding the fastening sections 14 with the teeth 16 analogously apply to the fastening sections 162 with the teeth 164.

The component opening in the first component 3 is shaped complementary to the second projections 134. Accordingly, the fastening element 110 is inserted into the first component 3 until the first projections 132 lie on the component surface.

In contrast to the previous embodiment, two third projections 138 are provided adjacent to the first projections 132. They are also arranged in a displaced manner by 180° to one another and are arranged in the tightening direction before the first projections 132. After a rotation of the fastening element 110 in tightening direction, the third projections 138 latch into the component opening so that a reverse motion lock or reverse rotation security as well as a security against overtightening is created. In this embodiment, a rotation by preferably 45° takes place.

Apart from that, the fastening arrangement 100 is assembled analogously to the previous fastening arrangement 1, so that the functionality arises from the above explanations, and is not mentioned again to avoid repetitions.

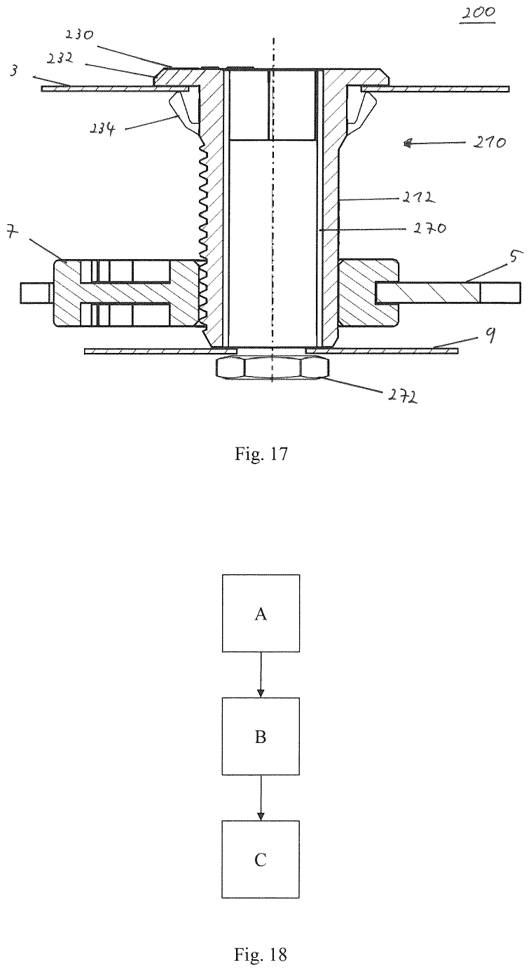

In FIG. 17, a perspective, sectional view of a component structure with another embodiment of the first alternative of an inventive fastening arrangement 200 is shown in a non-fastened state. The fastening arrangement 200 is also comprised of a hollow cylindrical fastening element 210 as well as a receiving opening 40 of the second component 5.

The fastening element 210 comprises a shaft portion 212 and a head portion 230. In contrast to the head portion 30 of the fastening element 10, the head portion 230 of the fastening element 210 has a circumferential flange 232 as well as a plurality of second projections 234, preferably, a plurality of latching noses projecting radially to the outside beyond the shaft portion 212. For example, four latching noses are present which are evenly arranged circumferentially.

The second projections 234 are axially spaced from the circumferential flange 232 in the direction of the shaft end. A distance in axial direction between the circumferential flange 232 and the second projections 234 preferably corresponds to a thickness of the first component 3 in the fastening portion.

A component opening in the first component 3 has a cylindrical shape. That way, the fastening element 210 can be inserted into the component opening of the first component 3 until the circumferential flange 232 lies on the surface of the first component 3 adjacent to the component opening. The second projections 234, in particular the latching noses, bounce radially to the outside after their inserting and fix the first component 3 between the circumferential flange 232 and the plurality of second projections 234.

As in case of the fastening element 10, the shaft portion 212 of the fastening element 210 is also alternately made of a fastening section and an insertion section in circumferential direction. With respect to the fastening section, the insertion section is displaced radially to the inside and preferably, it has a smooth configuration. Here, the fastening sections in axial direction are also preferably aligned with the second projections 234, whereas the insertion sections are arranged in between. For example, each fastening section and each insertion section have the same extension in circumferential direction.

With regard to the further configuration of the insertion section, of the fastening section and also of the receiving opening 40, reference is made to the above explanations regarding FIGS. 1 to 8.

When using the fastening element 210, firstly, the first component 3 and the second component 5 are arranged at the desired distance to one another and then, the fastening element 210 is inserted through the component opening in the first component 3. In this embodiment, the component opening is preferably configured cylindrically. As soon as the fastening element 210 has been inserted into the component opening in the first component 3, the first component 3 is fixed between the circumferential flange 232 and the second projections 234, in particular the latching noses.

Here, the receiving opening 40 is arranged in a way that the insertion section of the fastening element 210 is aligned with the projecting portion of the receiving opening 40 and the fastening section is aligned with the set-back portion. Thus, the fastening element 210 is guided in the receiving opening 40 in axial direction.

As soon as the circumferential flange 232 lies on the component surface of the first component 3, the position can be fixed in axial direction by rotating the fastening element 210. For this purpose, the fastening element 210 comprises a drive feature in the head portion 230. As discussed above, same can be configured as an inner or an outer drive feature. In the illustrated embodiment, it is an inner drive feature, e.g. in the shape of a hexagonal socket.

Due to the rotation of the fastening element 210, the teeth in the fastening section are brought into engagement with the projecting portions of the receiving opening. In doing so, the teeth preferably dig into the material of the projecting portions or the receiving opening, respectively. Therefore, the fastening element 210 is made of a material that is harder than the material in which the receiving opening 40 is formed. For example, the fastening element 210 is made of PPA-GF50 like the fastening element 10.

After the connection between the first 3 and the second component 5 has been established in this way, preferably, no further fastening element like a fastening screw or the like is necessary at this connection point in order to safely fasten the two components to each other.

As a variant, a fourth component 9 can be provided adjacent to the end of the shaft portion 212 facing away from the head, as illustrated in FIG. 17. For this purpose, the fourth component 9 comprises a nut 272 into which a fastening screw that is not illustrated can be screwed. The nut 272 can be an integral part of the fourth component 9 or an individual part that is firmly connected with the fourth component 9.

In order to limit a compression of the fastening element 210, a corresponding sleeve 270 is additionally provided inside of the fastening element 210. Alternatively to the sleeve 270, other elements may also be used which cause a corresponding stiffening of the fastening element 210.

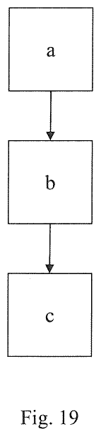

With reference to FIGS. 18 and 19, the corresponding fastening methods are now explained.

In the fastening method according to FIG. 18, an embodiment of the first alternative of the inventive fastening arrangement 1; 200 is used. In this context, the first component 3 is arranged with a desired distance to the second component 5 in a first step A, with the component opening of the first component 3 being aligned with the receiving opening 40 of the second component 5. Now, in step B, an inserting of the fastening element 10; 210 into the component opening of the first component 3 takes place until the circumferential flange 232 or the plurality of first projections 32 abuts the first component 3 and the shaft portion 12; 212 engages with the receiving opening 40 of the second component 5. Here, the insertion sections 18 are aligned with the projecting portions 42 and the fastening sections 14 are aligned with the set-back portions 44. In step C, the fastening element 1 is rotated, causing a fixing of the first component 3 at the second component 5 in axial direction.

When using the embodiment of the fastening element with the circumferential flange 232 and the plurality of second projections 234, preferably a plurality of latching noses, the inserting of the fastening element 210 into the component opening of the first component 3 already causes a fixing of the first component 3 between the circumferential flange 232 and the plurality of second projections 234.

When the embodiment of the fastening element 10 is used with the plurality of first 32 and second projections 34, the rotating after the inserting of the fastening element 10 into the component opening in the first component 3 does not only cause a fixing of the first component 3 to the second component 5 in axial direction but additionally a fixing of the first component 3 between the plurality of first 32 and second projections 34.

The fastening method according to FIG. 19 has an analogous functionality, whereas here, an embodiment of the second alternative of the inventive fastening arrangement 100 is used. Here as well, the first component 3 is arranged at a desired distance to the second component 5 in a first step a, with the component opening of the first component 3 being aligned with the securing element 160. In step b, the fastening element 110 is now inserted into the component opening of the first component 3, until the plurality of first projection 132 abuts the first component 3 and the shaft portion 112 engages with the securing element 160. Here, the projecting portions 122 are aligned with the insertion sections 166 of the securing element 160 and the set-back portions 124 are aligned with the fastening sections 162 of the securing element 160. Finally, in step c, a rotating of the fastening element 110 takes place which leads to a fixing of the first component 3 between the plurality of first 132 and second projections 134 as well as a fixing of the first component 3 to the second component 5 in axial direction.

### 6. LIST OF REFERENCE SIGNS

1 fastening arrangement
3 first component
5 second component
7 third component
9 fourth component
10 fastening element
12 shaft portion
14 fastening section
16 teeth
18 insertion section
20 web
30 head portion
32 first projection
34 second projection
36 rip
40 receiving opening
42 projecting portion
44 set-back portion
46 elastic element
50 fastening element
100 fastening arrangement
110 fastening element
112 shaft portion
122 projecting portion
124 set-back portion
130 head portion
132 first projection
134 second projection
138 third projection
160 securing element
162 fastening section
164 teeth
166 insertion section
200 fastening arrangement
210 fastening element
212 shaft portion
230 head portion
232 circumferential flange
234 second projection
270 sleeve
272 nut

1. A fastening arrangement for fastening a first component with a component opening to a second component with manual compensation of a distance therebetween, with the fastening arrangement comprising:
a. a hollow-cylindrical fastening element with a shaft portion and a head portion, wherein
a1. the head portion projects radially to the outside beyond the shaft portion with a circumferential flange or a plurality of first projections and a plurality of second projections, wherein the circumferential flange or the plurality of first projections and the plurality of second projections are arranged with a distance to one another in axial direction, so that a rim of the component opening in the first component is arrangeable between the circumferential flange or the plurality of first projections and the plurality of second projections and
a2. the shaft portion comprises a plurality of fastening sections and a plurality of insertion sections on its radial outside which are alternately arranged in circumferential direction and extend in axial direction between head portion and an axial end of the shaft portion, wherein the fastening sections project in radial direction beyond the insertion sections,
b. a receiving opening of the second component which in circumferential direction alternately comprises portions projecting radially in and being set-back radially in the receiving opening, so that
c. the fastening element is pluggable through the component opening in the first component into the receiving opening and is rotatable relative to the receiving opening, wherein a fixation of the first component between the circumferential flange and the plurality of second projections is caused by inserting the fastening element or between the plurality of first and second projections by rotating the fastening element as well as a fixation of the first component to the second component in axial direction is caused by rotating the fastening element.

2. (canceled)

3. The fastening arrangement according to claim 1, wherein at least one insertion section comprises an axially extending web adjacent to a fastening section, the web projecting radially from the insertion section and providing a stop for limiting the rotation of the fastening element for the respective, projecting portion.

4. The fastening arrangement according claim 1, wherein each fastening section comprises a plurality of teeth.

5. The fastening arrangement according to claim 4, wherein the teeth taper in the tightening direction of the fastening element and/or their radial extension becomes less.

6. The fastening arrangement according to claim 4, wherein
the teeth are arranged perpendicularly to a longitudinal axis that is defined by the shaft portion of the fastening element or perpendicularly to a longitudinal axis that is defined by the projection of the securing element or
b. two neighboring teeth are arranged mirror-symmetrically with respect to a plane between the teeth, the plane being aligned perpendicularly to the longitudinal axis, with the neighboring teeth enclosing an angle of 1° with the plane.

7. The fastening arrangement according to claim 1, wherein the fastening element includes a drive feature in the head portion.

8. The fastening arrangement according to claim 1 wherein the circumferential flange or the plurality of first projections is present adjacent to a first axial end of the fastening element and the plurality of second projections comprises at least one rip on a surface facing the circumferential flange or the plurality of first projections.

9. The fastening arrangement according to claim 1, wherein the fastening element is made of a material that is harder than the material in which the receiving opening is formed.

10. (canceled)

11. A component structure made of a first component with component opening and a second component, wherein the first and the second component are connected with each other by means of the fastening arrangement according to claim 1 with a distance to each other.

12. The component structure according to claim 11, wherein the receiving opening is an integral part of the second component or a separate third component which is arranged at the second component.

13. (canceled)

14. A fastening method for fastening a first component with a component opening to a second component by using the first alternative of the fastening arrangement according to claim 1, wherein the method comprises the steps:
a. arranging the first component at a required distance to the second component, with the component opening of the first component being aligned with the receiving opening of the second component,
b. inserting the fastening element into the component opening of the first component until the circumferential flange or the plurality of first projections abuts the first component and the shaft portion engages with the receiving opening of the second component, wherein the insertion sections are aligned with the projecting portions and the fastening sections are aligned with the set-back portions, after that,
c. rotating the fasting element so that a fixing of the first component at the second component is caused in axial direction.

15. (canceled)
